(19) United States
(12) Patent Application Publication
(10) Pub. No.: US 2024/0420009 A1
(43) Pub. Date: Dec. 19, 2024

(54) MODEL-AGNOSTIC MULTI-FACTOR METRIC DRIFT ATTRIBUTION

(71) Applicant: Adobe Inc., San Jose, CA (US)

(72) Inventors: Nimish Srivastav, Santa Clara, CA (US); Vijay Srivastava, San Jose, CA (US); Deepak Pai, Sunnyvale, CA (US)

(73) Assignee: Adobe Inc., San Jose, CA (US)

(21) Appl. No.: 18/210,756

(22) Filed: Jun. 16, 2023

(51) Int. Cl. G06N 20/00

(52) U.S. Cl. CPC G06N 20/00

(57) ABSTRACT

Multi-factor metric drift evaluation and attribution techniques are described. A drift attribution model is trained to compute, for a segment of input data that defines an observed value for a metric and observed values for each of a plurality of factors that influence the value of the metric, a contribution by each of the plurality of factors to the observed metric value. Drift observations output by the trained drift attribution model are further processed using a Shapely explainer to represent contributions of each of the metric factors, and their associated values, relative to one or more observed values of a metric during the time segment. The respective magnitude by which each metric factor affects an observed value of the metric is described in a metric drift report, which objectively quantifies respective impacts of a factor, relative to other factors that affect a metric.

### BACKGROUND

Key performance indicators (KPIs) are metrics that refer to quantifiable measures of performance for a given goal. KPIs provide achievement targets for individuals and entities, represent benchmark values for gauging accuracy of computational model outputs, represent milestones against which progress is measured, and are generally used to quantify decision-making criteria for a range of objectives. KPIs are often used to measure progress over a period of time, or to compare performance over different segments of time (e.g., relative to one another). KPIs are derived from various measurable factors or dimensions. In some scenarios different factors contributing to a KPI are additive (e.g., a value of one dimension affects a value of another dimension). Alternatively or additionally, in some scenarios different factors contributing to a KPI are non-additive, such that a dimension's value is not affected by a change in another dimension's value. Identifying how changes in values of one or more underlying factors manifests a change in a KPI or metric defined by the underlying factors thus presents a challenge, particularly when scaled to metrics defined by numerous underlying factors.

### SUMMARY

Multi-factor metric drift evaluation techniques are described that leverage a trained drift attribution model. The drift attribution model is trained to compute, for a segment of input data that defines an observed value for a metric and observed values for each of a plurality of factors that influence the value of the metric, a contribution by each of the plurality of factors to the observed metric value. Drift observations output by the trained drift attribution model are further processed using a Shapely explainer to represent contributions of each of the metric factors, and their associated values, relative to one or more observed values of a metric during the time segment. The respective magnitude by which each factor affects an observed value of the metric is described in a metric drift report, which objectively quantifies respective impacts of a factor, relative to other factors that affect a metric.

To enable performance of the described multi-factor metric drift attribution techniques, a model training system is described that trains the drift attribution model used to generate a metric drift report. The model training system does so by generating a baseline training dataset, which includes information describing a metric to be evaluated by the drift attribution model as well as information describing various factors that influence or otherwise affect a value of the metric. In addition to a baseline training dataset, the drift attribution model is trained on a plurality of perturbed datasets that each include an altered value for at least one of the plurality of factors that influence a metric, relative to the baseline training dataset. This training data causes the drift attribution model to learn relationships between each of the plurality of factors that affect a value of the metric and the value of the metric. Based on the learned relationships the drift attribution model quantifies how individual factors diverge from expected baseline values. In this manner, a metric drift report generated by the trained drift attribution model visually identifies different factors that affect a metric and identifies respective magnitudes by which each factor affects an observed value of the metric.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ multi-factor metric evaluation and attribution techniques described herein.

FIG. 2 depicts a system in an example implementation showing operation of a model training system of FIG. 1 in greater detail.

FIG. 3 depicts a system in an example implementation showing operation of a metric evaluation system of FIG. 1 in greater detail.

FIG. 4 depicts an example implementation of a metric drift report generated by the metric evaluation system of FIG. 1 in accordance with one or more implementations.

FIG. 5 depicts another example implementation of a metric drift report generated by the metric evaluation system of FIG. 1 in accordance with one or more implementations.

FIG. 6 depicts another example implementation of a metric drift report generated by the metric evaluation system of FIG. 1 in accordance with one or more implementations.

FIG. 7 is a flow diagram depicting a procedure in an example implementation of generating a metric drift report using the metric evaluation system of FIG. 1.

FIG. 8 is a flow diagram depicting a procedure in an example implementation of training a drift attribution model employed by the metric evaluation system of FIG. 1.

FIG. 9 illustrates an example system including various components of an example device that can be implemented as any type of computing device as described and/or utilized with reference to FIGS. 1-8 to implement embodiments of the techniques described herein.

### DETAILED DESCRIPTION

### Overview

KPIs and other metrics generally represent achievement targets for individuals and entities, benchmark values for gauging accuracy (e.g., of computational model outputs), milestones against which progress is measured, and are thus used in a range of applications for evaluating progress towards, or achievement of, objectives. KPIs are often used to measure progress over time, or to compare performance over different segments of time (e.g., relative to one another). KPIs are derived from various measurable factors or dimensions. Identifying how changes in values of one or more underlying factors manifests a change in a KPI or metric defined by the underlying factors thus presents a challenge, particularly when scaled to metrics defined by numerous underlying factors (e.g., hundreds or thousands of influencing factors).

For any metric (e.g., model performance metric, metric describing performance of a process, etc.), there will be some drift observed values that quantify the metric. A primary challenge in metric evaluation is linking metric drift to observable changes in datapoints from which the metric is derived (e.g., identifying how changes in one or more influencing factors affected the observed metric value). For instance, in the context of evaluating performance of a machine learning model, metric drift refers to a situation where the performance metrics of a machine learning model degrade over time due to changes in the data distribution. As a specific example, metric drift occurs when a relationship between the input features for the machine learning model and a target variable evolves or shifts in a way that the model was not originally trained to handle.

Metric drift can manifest in different forms. For example, if the data distribution changes, a machine learning model's accuracy, precision, recall, or other performance metrics may change (e.g., deteriorate). This change can have significant consequences, such as decreased predictive power, increased false positives or false negatives generated by the machine learning model, reduced overall model effectiveness, and so forth. Detecting and addressing metric drift is crucial for maintaining the performance of machine learning models and other systems or procedures that are evaluated by one or more metrics. Monitoring metric values over time and comparing observed metric values against expected metrics is helpful in identifying metric drift. However, when drift is identified, it remains a challenge to correctly identify or understand root causes for the metric drift.

This challenge in evaluating metric drift is compounded when evaluating drift in metrics having values that are influenced by numerous factors. The challenges are compounded even further when individual ones of the numerous factors have high cardinality (e.g., when individual factors can be quantified by hundreds or thousands of different possible values). Conventional approaches to evaluating metric drift (e.g., attributing observed drift in a metric to one or more factors that influence the metric) rely on human data experts, which is subject to several inherent problems. For instance, such conventional approaches are prone to human error (e.g., overlooking important details, misinterpreting data, and so forth) due to human analysis subjectivity. Furthermore, by virtue of relying on human expert opinions, conventional metric drift attribution approaches are unverifiable and unrepeatable (e.g., different experts may arrive at different conclusions when analyzing the same data, making it difficult to establish a consistent understanding of the underlying reasons for metric drift).

Additionally, conventional metric drift attribution approaches are unable to scale across different domains. Insights are limited to the knowledge and experiences of specific domain specialists and data scientists tasked with evaluating a specific metric, and each expert may have their own biases and perspectives, which can limit the breadth and depth of insights gained from the data. This restricts the ability to leverage data across diverse domains and hinders the development of a generalized and automated approach to deriving metric drift insights.

To address these conventional problems, multi-factor metric drift evaluation and attribution techniques are described. The multi-factor metric drift evaluation and attribution techniques are performed by a system that automatically detects changes in observed values for a metric and generates a metric drift report that includes information describing various factors that influence the value of the metric, as well as a magnitude by which individual ones of the various factors impacted an observed metric value. In some implementations, the metric drift report is generated to visually represent a magnitude by which each factor, as observed over a segment of time, impacts or affects the observed value of the metric for the segment of time. In this manner, the described techniques enable granular analysis of a metric and its associated factors over any duration, such as analysis describing why crop yields for a harvest season during a first year differed from crop yields for a harvest season during a second year.

To enable the described multi-factor metric drift evaluation and attribution techniques, a drift attribution model is trained to learn mappings between individual ones of a plurality of features that affect a metric and a resulting value of the metric. To train the drift attribution model, a model training system is described that generates a baseline training dataset, which includes information describing a metric to be evaluated by the drift attribution model as well as information describing various factors that influence or otherwise affect a value of the metric. The baseline training dataset thus represents an expected relationship between each of the multiple metric factors and a resulting value of the metric being evaluated. In addition to a baseline training dataset, the drift attribution model is trained on a plurality of perturbed datasets that each include an altered value for at least one of the plurality of factors that influence a metric, relative to the baseline training dataset.

The baseline training dataset and the perturbed training datasets are input to an untrained model (e.g., an untrained regression model) that, when trained using the training datasets, is output as the trained drift attribution model. During training, the drift attribution model learns a relationship, between each of the plurality of factors that affect a value of the metric and the value of the metric, based on the input training data. In one example, for each perturbed training dataset input to the untrained model, a coefficient of determination (e.g., an R2 score) is computed for the model, with respect to the baseline training dataset. Each R2 score generated during training is associated with a vector of features representing metric factors included in training datasets, and thus represents a deviation of a metric from its baseline, where the vector of features represent univariate and joint divergences of the factors relative to their baseline values.

The drift attribution model is trained to learn mappings from a space of divergences in feature distributions represented by the perturbed training datasets relative to the baseline training dataset using various divergence measures, such as a Kullback-Leibler divergence measure, a Jensen-Shannon divergence measure, a Wasserstein distance measure, and so forth. The drift attribution model is thus trained to identify, for a segment of input data that defines an observed value for a metric and observed values for each of a plurality of factors that influence the value of the metric, a contribution by each of the plurality of factors to the observed metric value. This automatic attribution of each factor's contribution to an observed metric value is identified by the drift attribution model based on divergences of the factors' values relative to the baseline training dataset.

Drift observations for a time segment output by the trained drift attribution model are then processed using a Shapely explainer to represent contributions of each of the metric factors, and their associated value(s), relative to one or more observed values of a metric during the time segment. Via the combination of training the drift attribution model to identify divergences of metric factors and their resulting magnitude of affecting a metric, and implementing a Shapley explainer to quantify the impact of each metric factors, a metric drift report is generated. In some implementations, the metric drift report is generated to visually identify different factors that affect a metric as well as respective magnitudes by which each factor affects the metric.

Advantageously, in contrast to conventional techniques that rely on subjective opinions of domain or subject matter experts, the described techniques are not prone to human error or opinion. Further, the described techniques are scalable to generate metric drift reports for metrics that are influenced by any number of factors, derived from underlying empirical data that describes observed values for each factor influencing a metric. Thus, in contrast to conventional approaches, metric drift reports generated in accordance with the techniques described herein objectively quantify how various factors observed during a time period affected a metric derived from the factors. Significantly, the described techniques attribute metric drift to underlying factors in a model-agnostic manner, such that the drift attribution model is trained to generate a metric drift report without knowledge regarding an underlying process by which the metric value was computed. The metric drift reports described herein are thus useable to describe whether observed characteristics of individual factors should be replicated or avoided to achieve an improved metric value in the future. Further discussion of these and other examples and advantages are included in the following sections and shown using corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

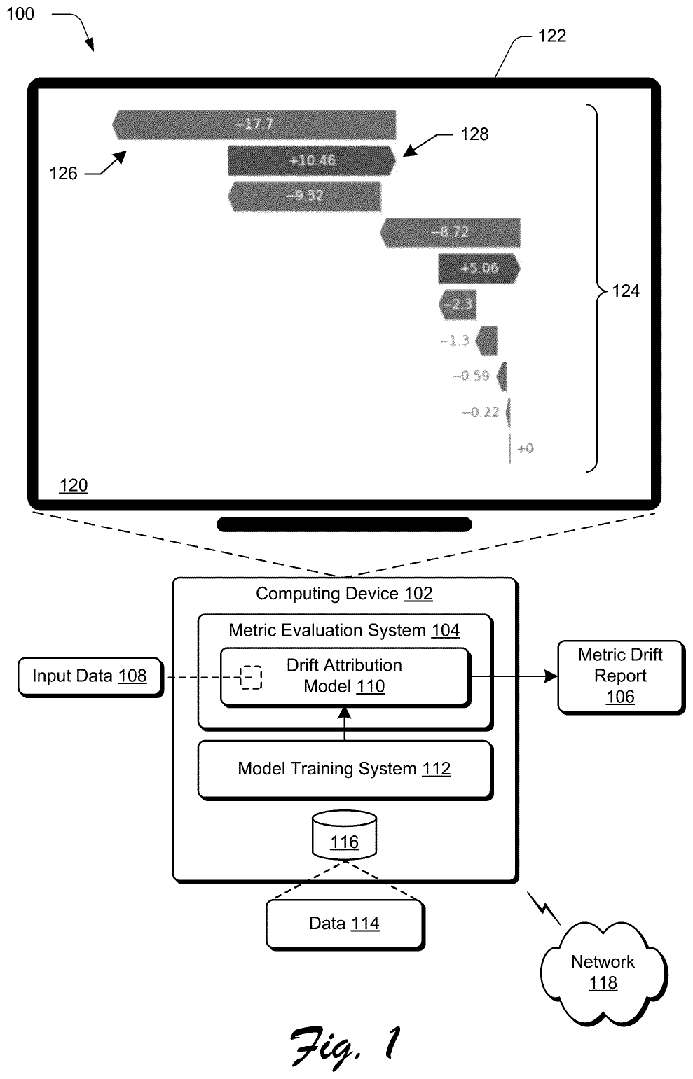

FIG. 1 is an illustration of a digital medium environment 100 in an example implementation that is operable to employ the multi-factor metric drift evaluation and attribution techniques described herein. The illustrated environment 100 includes a computing device 102, which is configurable in a variety of ways.

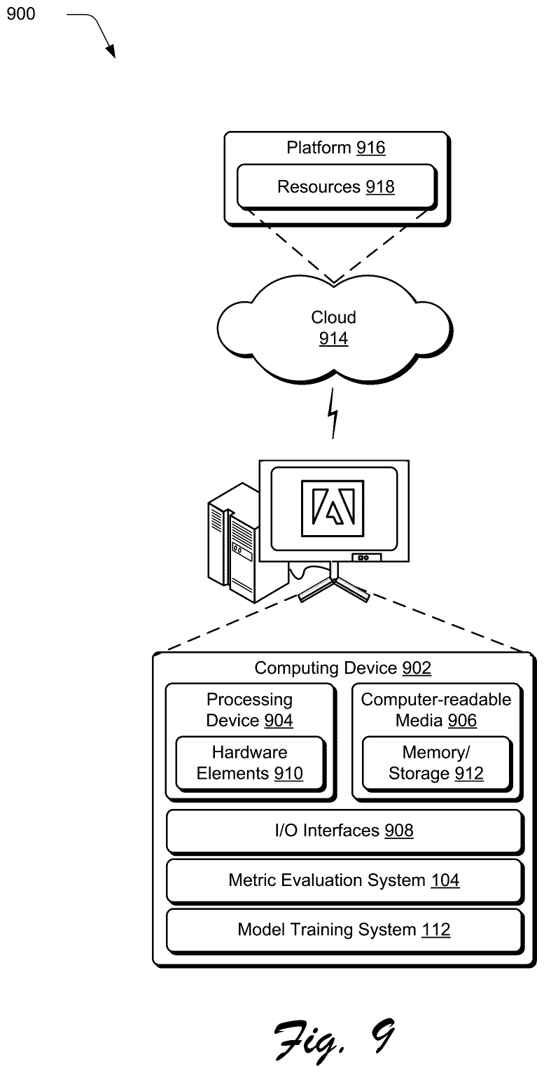

The computing device 102, for instance, is configurable as a desktop computer, a laptop computer, a mobile device (e.g., assuming a handheld configuration such as a tablet or mobile phone as illustrated), and so forth. Thus, the computing device 102 ranges from full resource devices with substantial memory and processor resources (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform operations “over the cloud” as described in FIG. 9.

The computing device 102 is illustrated as including a metric evaluation system 104. The metric evaluation system 104 is implemented at least partially in hardware of the computing device 102 to generate a metric drift report 106, based on input data 108. The input data 108 represents information describing the value for a metric (e.g., a value for a KPI) and one or more values for a plurality of different factors that collectively define the value for the metric. To do so, the metric evaluation system 104 employs a drift attribution model 110. The computing device 102 is further depicted as including a model training system 112.

The model training system 112 represents functionality of the computing device to train the drift attribution model 110 in a manner that causes the drift attribution model to learn mappings between individual ones of the plurality of features, and/or combinations of multiple features, that affect the value for the metric and the resulting value for the metric. In implementations, the input data 108 and/or training data (not depicted in FIG. 1) used to train the drift attribution model 110 represents data 114 maintained storage 116 of the computing device 102. Alternatively or additionally, in some implementations the input data 108, data used by the model training system 112 to train the drift attribution model 110, or a combination thereof is obtained from a data storage location for remote from the computing device 102. For instance, the input data 108, data used to train the drift attribution model 110, or a combination thereof is obtained from a data storage location (e.g., another computing device) communicatively coupled to the computing device 102 via network 118. Although illustrated as implemented locally at the computing device 102, functionality of the metric evaluation system 104, the model training system 112, or a combination thereof is configurable as whole or in part via functionality available via the network 118, such as part of a web service or “in the cloud.”

The input data 108 includes information describing at least one value for each of a plurality of factors observed over a period (e.g., a time segment) as well as a value of a metric. The plurality of factors collectively define the value of the metric and individually influence the value of a metric at varying degrees (e.g., relative to degrees by which other factors of the plurality of factors influence the value of the metric). The drift attribution model 110 is thus representative of a machine learning model trained by the model training system 112 to learn a baseline value for each of a plurality of factors that affect a resulting metric value, where the baseline value for a factor represents a magnitude by which the factor is predicted to affect the metric value (e.g., relative to other factors of the plurality of factors).

In some implementations, the drift attribution model 110 is generated from an untrained model having a decision tree regressor model architecture, which is trained by the model training system 112 to learn the baseline value for each of the plurality of factors. Although described herein with example reference to a decision tree regressor model architecture, the untrained model used by the model training system 112 is configurable using a variety of different architectures. For instance, in some implementations the drift attribution model 110 is generated from an untrained model having a regularized regression architecture, a support vector regression architecture, ensemble model architectures such as random forests and gradient boosting machines, and so forth. In implementations, the model training system 112 is configured to select, from multiple different model architectures, a model architecture for use in training the drift attribution model 110 that best maps feature divergences to observed metric drift under a five-fold cross validation process. Under a five-fold cross validation process, the model training system, the model training system 112 separates training data into five parts or “folds.” The model training system 112 then iteratively trains each model architecture on four of the training data folds and validates the model architecture on the remaining fold. This process is repeated five times, where a different “fold” is used for validation each time. The resulting five measures of performance are then averaged and used to select a model architecture that exhibits the highest fraction of variance in the training data space, and the selected model architecture is used to train the drift attribution model 110.

Given the input data 108, the drift attribution model 110 is configured to identify when one or more factor values represented in the input data 108 diverge from baseline values learned by the drift attribution model 110 during training. In response to identifying divergence from respective baseline values, the drift attribution model 110 generates a metric drift report 106 that quantifies the impact of a factor value—or set of multiple values—included in the input data 108 and observed over a period of time, relative to the metric value observed for the period of time and reflected in the input data 108.

The illustrated example of FIG. 1 depicts an example of a metric drift report 106 generated by the metric evaluation system 104 as displayed in a user interface 120 for output by computing device 102 (e.g., via a display device 122). As depicted in FIG. 1, the metric drift report 106 includes information that visually identifies a plurality of factors 124 that collectively affect a resulting value for a metric, where observed values for each of the plurality of factors 124 and an observed value for the metric are included in the input data 108. The metric drift report 106 depicts a magnitude by which each of the plurality of factors, as observed over a segment of time represented by the input data, impacts or affects the observed value of the metric for the segment of time.

For instance, in the illustrated example of FIG. 1, the metric drift report 106 indicates that factor 126 is determined to have the most significant impact on the resulting value of the metric represented in input data 108, and that value(s) of the factor 126 represented in input data 108 had a negative impact on the metric represented by the input data 108. The metric drift report 106 further indicates that factor 128 is determined to have a second most significant impact on the resulting value of the metric represented in input data 108, and that value(s) of the factor 128 represented in the input data 108 had a positive impact on the metric represented by the input data 108.

In this manner, the metric drift report 106 quantifies how various factors observed during a time period affected a metric derived from the factors, and indicates whether individual factors should be replicated (e.g., factor 128) or avoided (e.g., factor 126) to achieve an improved metric value for a future time period. This functionality of the metric evaluation system 104 is not possible using conventional techniques which rely on subjective opinions of subject matter experts that are inconsistent, are prone to human error, and cannot scale to analyze metrics that are influenced by a large number of factors. Further discussion of these and other advantages is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Multi-Factor Metric Drift Evaluation and Attribution

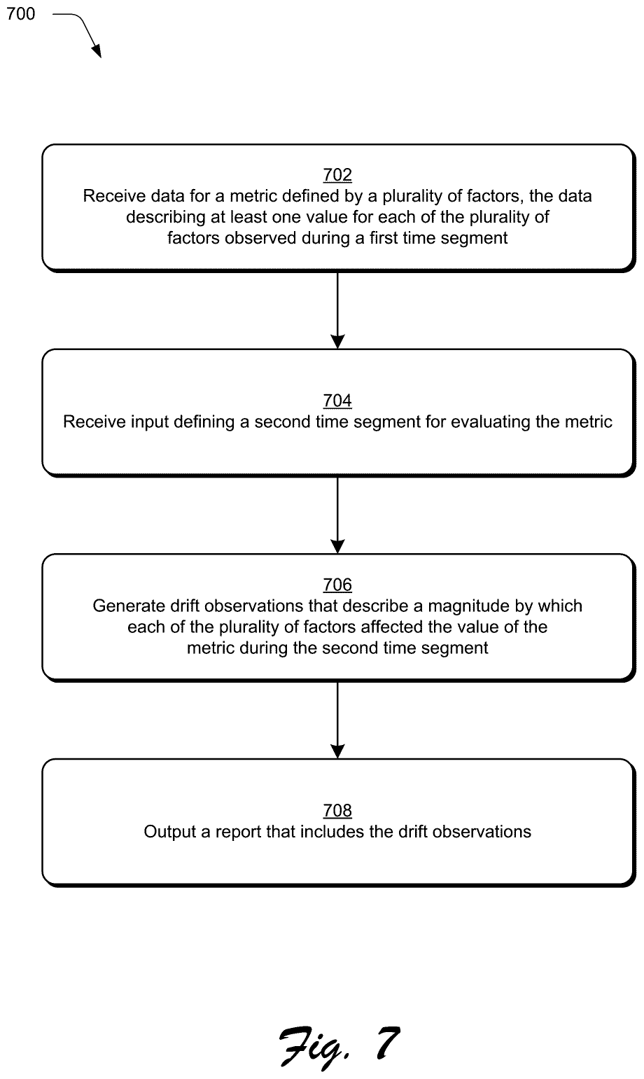

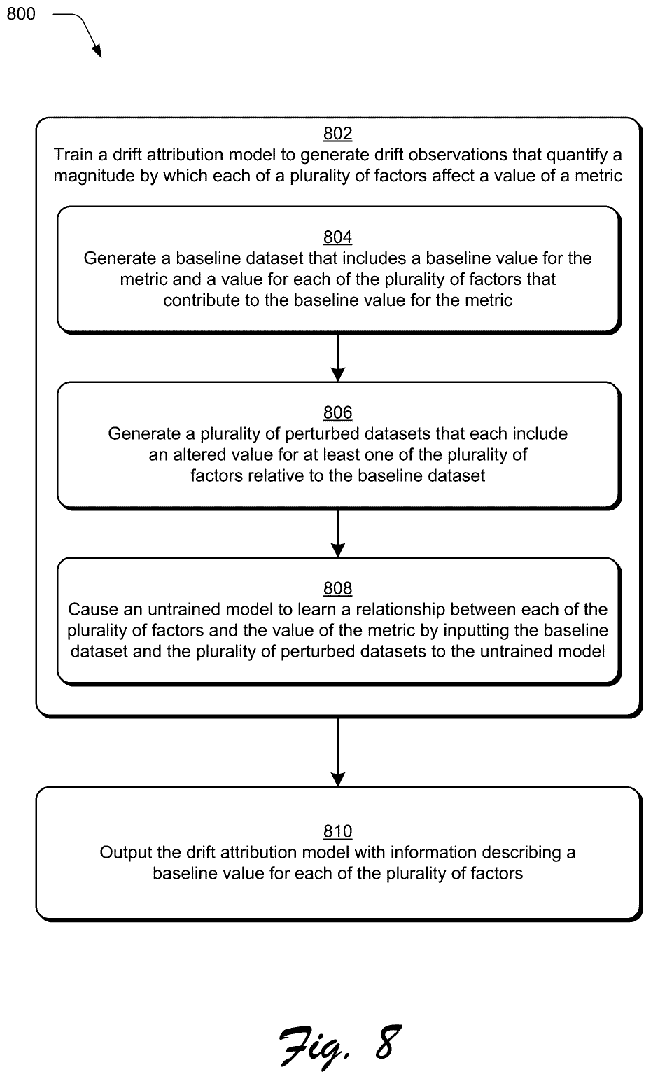

The following discussion describes multi-factor metric drift evaluation and attribution techniques in the context of algorithmic procedures that are implementable utilizing the systems and devices described herein. Aspects of the procedures are implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-6 and in parallel to the procedure 700 of FIG. 7 and the procedure 800 of FIG. 8.

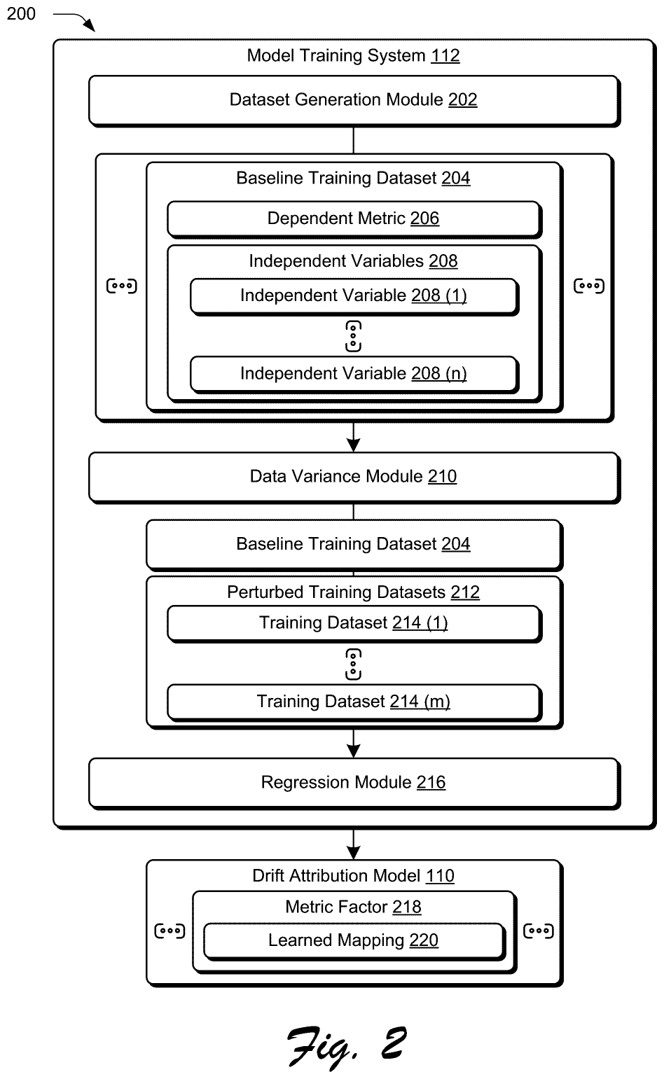

FIG. 2 depicts a system 200 in an example implementation showing operation of the model training system 112 of FIG. 1 generating a trained drift attribution model 110 implemented by the metric evaluation system 104 in accordance with aspects of the techniques described herein (block 802). In the illustrated example of FIG. 2, the model training system 112 includes a dataset generation module 202 configured to generate a baseline training dataset 204 for use in training the drift attribution model 110 (block 804).

The baseline training dataset 204 includes information describing a dependent metric 206 (e.g., a KPI) as well as a plurality of independent variables 208 that affect the dependent metric 206, such that a value of the dependent metric 206 is derived from one or more values of each of the independent variables 208. In the depicted example, the independent variables 208 are illustrated as representing n different independent variables, where n represents any integer. Each of the independent variables 208 (e.g., independent variable 208(1) to independent variable 208(n)) is thus representative of a factor that affects a value of the dependent metric 206.

The dependent metric 206 is representative of any suitable type of performance indicator defined by multiple factors. For instance, in one example the dependent metric 206 represents a predicted yield for a crop, where the independent variables 208 represent factors such as soil type, weather patterns, farming equipment used, planting season, harvest season, and so forth. As another example, the dependent metric 206 represents traffic conditions for urban planning and transportation objectives (e.g., traffic congestion for a highway), where the independent variables 208 represent factors such as time of day, weather, day of the week, and so forth. As yet another example, the dependent metric 206 represents a likelihood of manufacturing equipment failure, where the independent variables 208 represent factors such as equipment age, equipment usage patterns, maintenance history, operator experience, and so forth. In another example, the dependent metric 206 represents a predicted property value, where the independent variables 208 represent factors such as location, square footage, number of rooms, age of property, time of the year, and so forth. As another example, the dependent metric 206 represents an amount of energy consumption, where the independent variables 208 represent factors such as past consumption metrics, weather patterns, type of energy consuming devices (e.g., appliances, lighting fixtures, electronics, etc.), weather patterns, time of day, and so forth.

Thus, the techniques described herein are extendable to a range of different metrics that are each quantified based on a variety of different factors. Accordingly, although described with respect to different examples, the techniques described herein are not so limited to the described examples.

In some implementations, the dataset generation module 202 generates the baseline training dataset 204 based on user input indicating that data included in the baseline training dataset 204 (e.g., a value of the dependent metric 206, enumerated factors represented by the independent variables 208, and respective value(s) of each independent variable 208(1)-208(n)) should be used as a baseline for evaluating the dependent metric 206. Alternatively, in some implementations the dataset generation module 202 identifies a baseline training dataset 204 automatically-independent of (e.g., without) user input.

For instance, in an example scenario the model training system 112 receives data describing values for the dependent metric 206 that are observed over time (e.g., a dependent metric 206 value for each of a plurality of time segments that results from observed values of the independent variables 208 during the time segment). In such an example scenario the data describing past, observed, values for the dependent metric 206 and its independent variables 208 is obtained by the model training system 112 from the storage 116 of computing device 102, from one or more other computing devices (e.g., via network 118), combinations thereof, and so forth.

In such implementations of automatically identifying a baseline training dataset 204, the dataset generation module 202 selects a mean observed value of the dependent metric 206, a median observed value of the dependent metric 206, a mode of an observed value of the dependent metric 206, or combinations thereof for defining the baseline training dataset 204. In a similar manner, the dataset generation module 202 selects one or more values for each of the independent variables 208 for use in generating the baseline training dataset 204 that were observed to result in the selected value for the dependent metric 206 represented in the baseline training dataset 204. In this manner, the baseline training dataset 204 represents a baseline (e.g., an expected or optimal) manner in which values of independent variables 208 influence a corresponding value for a dependent metric 206.

For instance, consider an example scenario where the dataset generation module 202 generates a baseline training dataset 204 for a dependent metric 206 that has a value defined by two independent variables 208. In this example scenario, the dependent metric 206 is represented as y and the two independent variables 208 are represented as X0 and X1. In the example scenario, based on observed values for the dependent metric 206, the independent variable X0 is modeled as having a Gaussian distribution (e.g., a normal distribution visually representable as a bell curve) with an average value of five and a standard deviation of one. Similarly, based on observed values for the dependent metric, the independent variable X1 is modeled as having a Gaussian distribution with an average value of six and a standard deviation of 0.5. In such an example scenario, the baseline training dataset 204 selects values for the independent variables 208 to include in the baseline training dataset 204 such that X0=5 and X1=6, representing average observed values of the independent variables 208.

From the observed values of the dependent metric 206, and corresponding observed values of the independent variables 208, the dataset generation module 202 is configured to derive an estimated relationship between the independent variables 208 and the dependent metric 206. For instance, continuing the example scenario described above, the dataset generation module 202 derives a relationship between the dependent metric 206 and the independent variables 208 represented in the baseline training dataset 204 according to Equation 1:

$$y = AX + b + e \qquad ( Eq . 1 )$$

In Equation 1, y represents the dependent metric 206 and X represents a vector that includes the respective values of independent variables 208 that cause a resulting value of the dependent metric 206. Equation 1 further represents a weighted influence by which each of the independent variables 208 influence the resulting value of dependent metric 206 using the coefficient matrix A. For instance, continuing the example scenario above, if A=[2,3], such a coefficient matrix indicates that X0 has an estimated impact on the dependent metric 206 quantified by two and that X1 has an estimated impact on the dependent metric 206 quantified by three.

In this manner, the coefficient matrix A represents a magnitude by which changes to one of the independent variables 208 are estimated to affect a resulting value of the dependent metric 206 (e.g., relative to changes in values of other independent variables 208). In Equation 1, b represents an estimated constant term or intercept that affects a resulting value of the dependent metric 206 (e.g., independent of value changes for the independent variables 208) and e represents an error term to account for variability or noise in a relationship between the independent variables 208 and the dependent metric 206. For instance, continuing the example scenario from above, the dataset generation module 202 identifies that b=0.5 and e˜N (0,0.1), which indicates that the error follows a normal distribution N (0,0.01), where 0 is the mean and 0.01 is the variance. In this manner, the baseline training dataset 204 generated by the dataset generation module 202 (e.g., based on user input specifying baseline conditions to use for modeling a metric and/or automatically based on observed values for a metric and the multiple factors that influence the observed metric values) represents an ideal correlation between each of the independent variables 208 and the dependent metric 206.

As further part of generating a trained drift attribution model 110, the dataset generation module 202 provides the baseline training dataset 204 to a data variance model 210. The data variance model 210 represents functionality of the model training system 112 to generate a plurality of perturbed datasets that each include an altered value for at least one of the plurality of factors that influence a metric (e.g., at least one of the independent variables 208) relative to the baseline training dataset 204 (block 806). This is depicted in the illustrated example of FIG. 2 as the perturbed training datasets 212 generated by the data variance model 210.

In implementations, the perturbed training datasets 212 include m different training datasets 214 (e.g., training dataset 214(1) to training dataset 214(m), where m represents any integer. Each training dataset 214 includes a value for a metric (e.g., a value for a dependent metric 206) resulting from a plurality of factors that affect the metric (e.g., values for each of the independent variables 208) observed during a time segment represented by the training dataset 214. The perturbed training datasets 212 thus represent deviations from respective values of the dependent metric 206 and the independent variables 208 included in the baseline training dataset 204. Collectively, the deviations from baseline values represented by the perturbed training datasets 212 indicate how changes in observed values of the independent variables 208 affect resulting values of the dependent metric 206, and thus enable the drift attribution model 110 to learn relationships between individual ones of the independent variables 208 and the dependent metric 206 during training.

In some implementations, provided a sufficient sample size of observed values for independent variables 208 and the dependent metric 206 (e.g., responsive to having observed values for a threshold number of time segments), the perturbed training datasets 212 represent a portion or entirety of observed values for the metric (e.g., the dependent metric 206) and observed values for factors that influence the metric (e.g., the independent variables 208). In such implementations, the perturbed training datasets 212 represent observed values for a dependent metric 206 and its associated independent variables 208 during time segments other than a time segment represented by the baseline training dataset 204. Alternatively or additionally, in some implementations the data variance model 210 is configured to generate new values for one or more independent variables 208 and a corresponding value for a dependent metric 206 that results from the generated independent variable values. In implementations, the data variance model 210 generates new values representing factors that affect a metric value to promote convergence of the drift attribution model 110 during training.

For instance, consider the example scenario noted above where the dependent metric 206 is modeled according to Equation 1 and represented as y, with a value derived from respective values of independent variables 208 X0 and X1. As noted above, in this example scenario X0 is observed as having values that are representable using a Gaussian distribution having an average value of five and a standard deviation of one and X1 is observed as having a Gaussian distribution with an average value of six and a standard deviation of 0.5. To account for variance in future observed values of various independent variables 208 and a resulting observed value of a dependent metric 206, the data variance model 210 is configured to supplement the baseline training dataset 204 with observed and/or simulated training datasets.

As a specific example, one or more of the training datasets 214 are generated to include independent variables 208 with values that reflect the variable distributions modeled by the baseline training dataset 204. For instance, a training dataset 214 is generated by assigning a value to X0 by drawing from a Gaussian distribution with a mean of five and a standard deviation of one and assigning a value to X1 by drawing from a Gaussian distribution with a mean of six and a standard deviation of 0.5. In this example training dataset 214, a value of the dependent metric 206 is computed using the values assigned to X0 and X1 according to Equation 1.

Alternatively or additionally, one or more of the training datasets 214 are generated to include independent variables 208 with values that differ from the variable distributions modeled by the baseline training dataset 204. For instance, in one example a training dataset 214 includes a value of X0 drawn from the Gaussian with a mean of five and a standard deviation of one (e.g., the baseline distribution) while the value of X1 is drawn from a different distribution than its baseline distribution (e.g., a Gaussian with a mean of five and a standard deviation of two). Alternatively or additionally, a training dataset 214 includes a value of X0 drawn from a distribution that differs from its baseline distribution, such as from a Gaussian with a mean of six and a standard deviation of three.

In implementations, the data variance model 210 generates the perturbed training datasets 212 by selects observed data and/or synthesizing simulated data, such that the perturbed training datasets 212 represent a range of different values for metric factors and values of the metric that result from these range of different factors. For instance, in one example implementation one or more of the training datasets 214 include independent variables 208 with values that reflect distributions identified by the dataset generation module 202 for generating the baseline training dataset 204. In this manner, training datasets 214 that reflect baseline distributions provide additional training examples for modeling independent variable distributions and a dependent metric 206 distribution represented by the baseline training dataset 204.

Continuing this example implementation, one or more of the training datasets 214 include a first subset (e.g., one or more) of independent variables 208 having values that reflect their baseline distributions and a second subset of independent variables 208 having values that reflect slight deviations from their baseline distributions. Continuing this example implementation, one or more of the training datasets 214 include a first subset of independent variables 208 having values that reflect their baseline distributions and a second subset of independent variables 208 having values that reflect significant deviations from their baseline distributions.

Further to this example implementation, one or more of the training datasets 214 include a first subset of independent variables 208 having values that reflect slight deviations from their baseline distributions and a second subset of independent variables 208 having values that reflect significant deviations from their baseline distributions. In this example implementation, one or more of the training datasets 214 represent each of the independent variables 208 using values that significantly deviate from the respective independent variable distributions represented in the baseline training dataset 204. In implementations, a degree or magnitude by which a value is considered to slightly or significantly deviate from a baseline distribution is defined for a particular metric the drift attribution model 110 is being trained to evaluate, and such deviations are not limited by the techniques or examples described herein.

In this manner, the perturbed training datasets 212 represents data points that allows for testing and training on diverse data in comparison to the baseline training dataset 204. The baseline training dataset 204 and the perturbed training datasets 212 are then communicated to a regression module 216 for use in training and outputting the drift attribution model 110.

The regression module 216 represents functionality of the model training system 112 to cause a regression model to learn a relationship, between each of the plurality of factors that affect a value of the metric and the value of the metric, using the baseline training dataset 204 and the perturbed training datasets 212 (block 808). In some implementations, the regression module 216 obtains a regression model (e.g., a decision tree regressor model) from storage 116 of the computing device 102 implementing the model training system 112. Alternatively, the regression module 216 obtains the regression model from another source, such as from a different computing device via the network 118.

To train the drift attribution model 110, the regression module 216 initializes a regression model by designating different features the drift attribution model 110 will be tasked with learning for a given metric (e.g., designating the independent variables 208 for the dependent metric 206) represented in the baseline training dataset 204 and each of the perturbed training datasets 212. The regression module 216 then inputs the baseline training dataset 204 and the perturbed training datasets 212 to the regression model and tasks the regression model with learning relationships between each of the independent variables 208 and the dependent metric 206. In accordance with one or more implementations, tasking the regression model with learning the relationships between the dependent metric 206 and the independent variables 208 is performed using an objective that causes the regression model to learn how to partition the feature space represented by training data. For instance, in an implementation where the drift attribution model 110 is generated with a decision tree regression model architecture, training involves an objective that causes the model to learn decision tree splits that minimize the sum of squared differences between values represented by the perturbed training datasets 212 and the baseline training dataset 204. In one example, for each perturbed training dataset 212 input to a regression model, the regression module 216 computes a coefficient of determination (e.g., an R2 score) for the model, with respect to the baseline training dataset 204. In one example, an R2 score is computed according to Equation 2, where SSᵣₑₛ refers to the sum of squares of residual errors and SSₜₒₜ refers to the sum of squares of residuals from the baseline training dataset 204:

$$R 2 = 1 - \frac{{SS}_{res}}{{SS}_{tot}} \qquad ( Eq . 2 )$$

Each R2 score generated during training (e.g., via input of one of the perturbed training datasets 212 to a regression model) is associated by the regression module 216 with a vector of features (e.g., values of the dependent metric 206 and the independent variables 208 represented in the perturbed training dataset 212). The R2 score thus represents a deviation of the dependent metric 206 from the baseline training dataset 204, where the vector of features represent univariate and joint divergences of the independent variables 208 relative to the baseline training dataset 204. The regression module 216 uses the vector of features associated with each R2 score resulting from processing a perturbed training dataset 212 using the regression model and causes the regression model to learn a mapping from the space of divergences in feature distributions to a deviation of a value of the dependent metric 206 as represented in the perturbed training dataset 212, relative to the baseline value represented in the baseline training dataset 204. The regression model with learned mappings from the space of divergences in feature distributions represented by the perturbed training datasets 212 relative to the baseline training dataset 204 is then output by the regression module 216 as the trained drift attribution model 110.

In implementations, the regression module 216 trains the drift attribution model 110 to learn mappings from the space of divergences in feature distributions represented by the perturbed training datasets 212 relative to the baseline training dataset 204 using a Kullback-Leibler (KL) divergence measure (e.g., a relative entropy measure), which quantifies the difference between different probability distributions. For instance, in implementations where the regression module 216 uses KL divergence for training the drift attribution model 110, KL divergence measures are of relative entropy from a feature distribution represented by the baseline training dataset 204 to a feature distribution represented by a perturbed training dataset 212. Mathematically, a KL divergence measure is expressed by Equation 3, where Q and P represent different distributions (e.g., feature distributions of the baseline training dataset 204 and a perturbed training dataset 212).

$${D}_{KL} ( P \vert \vert Q ) = - {\sum }_{x ∈ X} P ( x ) log ( \frac{Q ( x )}{P ( x )} ) \qquad ( Eq . 3 )$$

Alternatively or additionally, in some implementations the regression module 216 trains the drift attribution model 110 to learn mappings from the space of divergences in feature distributions represented by the perturbed training datasets 212 relative to the baseline training dataset 204 using a Jensen-Shannon (JS) divergence measure. In contrast to KL divergence, which is not symmetric, JS divergence is symmetric, meaning that the JS divergence of P from Q is the same as the JS divergence of Q from P, which is not the case for (KL) divergence. Mathematically, a JS divergence measure is expressed by Equation 4, where Q and P represent different distributions (e.g., feature distributions of the baseline training dataset 204 and a perturbed training dataset 212) and

$$M = \frac{1}{2} \times ( P + Q ) .$$

$${D}_{JS} ( P \vert \vert Q ) = \frac{1}{2} \times {D}_{KL} ( P \vert \vert M ) + \frac{1}{2} \times {D}_{KL} ( Q \vert \vert M ) \qquad ( Eq . 4 )$$

Alternatively or additionally, in some implementations the regression module 216 trains the drift attribution model 110 to learn mappings from the space of divergences in feature distributions represented by the perturbed training datasets 212 relative to the baseline training dataset 204 using Wasserstein distance. Wasserstein distance refers to a measure of distance between two probability distributions that takes into account the underlying geometric structure of a data space. For instance, given two probability distributions P and Q over a given metric space, the Wasserstein distance is defined as the infimum over all possible joint distributions gamma of (P, Q) of the expected distance between random points drawn according to gamma.

During training, the regression module 216 updates internal weights of the drift attribution model 110 (e.g., weights defining hyperparameters such as maximum depth of the regression tree, minimum number of samples required to split an internal node of the regression tree, minimum number of samples required to be at a leaf node of the regression tree, and so forth). In implementations, the regression module 216 tunes hyperparameters of the drift attribution model 110 using grid search techniques, random search techniques, combinations thereof, and so forth.

The regression module 216 then outputs the trained regression model as the drift attribution model 110 (block 810). As depicted in the illustrated example of FIG. 2, the drift attribution model 110 is output with data describing each metric factor 218 that influences a metric the drift attribution model 110 is trained to evaluate (e.g., each of the independent variables 208 that influences the dependent metric 206) and a learned mapping 220 that describes how changes in values of the metric factor 218 affect a resulting value of the metric being evaluated. The drift attribution model 110 is thus trained to identify, for a segment of input data that defines an observed value for a metric and observed values for each of a plurality of factors that influence the value of the metric, a contribution by each of the plurality of factors to the observed metric value, based on divergences of the factors' values relative to the baseline training dataset 204.

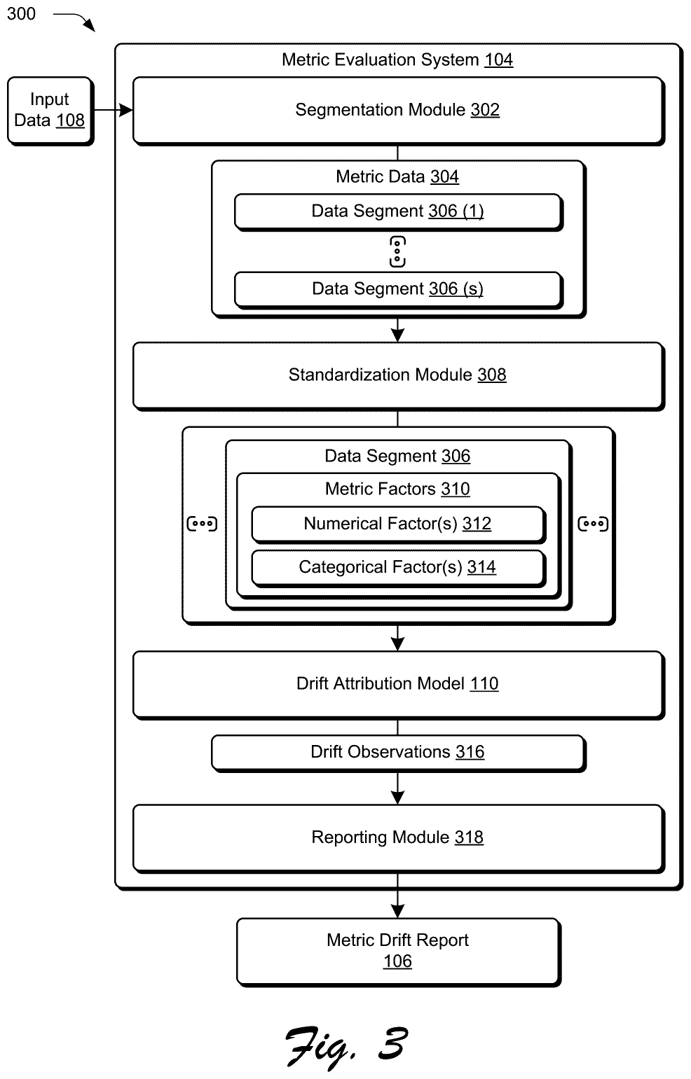

FIG. 3 depicts a system 300 in an example implementation showing operation of the metric evaluation system 104 generating a metric drift report 106 for input data 108 using a drift attribution model 110 generated by the model training system 112.

In the illustrated example of FIG. 3, the metric evaluation system 104 is depicted as receiving input data 108, which represents data for a metric defined by a plurality of factors, where the data describes at least one value for each of the plurality of factors observed during a first time segment (block 702). For example, the metric evaluation system 104 receives input data 108 that describes observed crop yields (e.g., observed values for a dependent metric that quantifies crop yields) during a first time segment and corresponding values describing observed factors such as soil type, weather patterns, farming equipment used, planting season, harvest season, and so forth, which contributed to the observed crop yields during the first time segment.

As part of receiving the input data 108, the metric evaluation system 104 receives an indication of a second time segment for evaluating the metric (block 704). The metric evaluation system 104, for instance, receives user input defining a time segment for which a metric is to be evaluated, which may be a portion or an entirety of time encompassed by the first time segment. For instance, the metric evaluation system 104 receives user input defining a certain month during which a crop yield metric is to be evaluated, based on values defining various factors that influence the crop yield metric during the certain month. Although described herein with respect to a time segment, the input data 108 is useable to define any instance or period of time over which a metric is to be evaluated (e.g., a single output of a machine learning model, outputs of a machine learning model generated over one or more durations, combinations thereof, and so forth). Further, although described herein in the context of “first” and “second” time segments, the designation of “first” or “second” is not temporally constricting (e.g., a “second” time segment may encompass a portion of time that occurred prior to a portion of time encompassed by a “first” time segment, or vice versa).

The metric evaluation system 104 includes a segmentation module 302, which represents functionality of the metric evaluation system 104 to identify different segments of metric data 304 included in the input data 108 (e.g., different months of data defining a crop yield metric and its associated factors). Segments by which the segmentation module 302 partitions the input data 108 to generate metric data 304 are representative of any suitable time range (e.g., microseconds, seconds, minutes, hours, days, weeks, months, years, etc.), without restriction or limitation by the examples described herein. For instance, using a monthly segment example, the segmentation module 302 is configured to generate metric data 304 to include a plurality of data segments 306 (e.g., data segment 306(1) . . . data segment 306(s)), where each data segment 306 includes data (e.g., values) for a metric and its factors as observed over a month. In this manner, s represents any suitable integer.

The metric evaluation system 104 further includes a standardization module 308, which represents functionality of the metric evaluation system 104 to process data represented in each data segment 306 to achieve a format similar to a data format used to train the drift attribution model 110 (e.g., a format by which values of the dependent metric 206 and independent variables 208 are represented in the baseline training dataset 204 and the perturbed training datasets 212). For instance, in the illustrated example of FIG. 3, each data segment 306 includes information describing metric factors 310 that affect a value of a metric being evaluated, where individual metric factors 310 are classified as either a numerical factor 312 or a categorical factor 314. In implementations, metric factors 310 included in a data segment 306 include multiple factors comprised of one or more numerical factors 312, one or more categorical factors 314, or combinations thereof.

In some implementations a numerical factor 312 included in a data segment 306 is output by the standardization module 308 in terms of a count histogram, such that the standardization module 308 organizes data for a factor (e.g., an independent variable 208) into bins or intervals and counts a number of occurrences or frequencies within each bin. In such implementations, a bin size or range of values is configurable in any suitable manner, such as in alignment with bin sizes or ranges of values represented in training data for the drift attribution model 110.

In some implementations a categorical factor 314 included in a data segment 306 is output by the standardization module 308 in terms of a frequency, such that the standardization module 308 counts an occurrence of each category or class of factors (e.g., number of days with temperatures that exceed a threshold temperature value) that affect a metric being evaluated. In such implementations, different categories or classes of factors to be represented in the metric factors 310 is determined based on factors represented in training data for the drift attribution model 110 (e.g., based on independent variables 208 represented in the baseline training dataset 204 and perturbed training datasets 212).

Data for one or more data segments 306 that are to be used for evaluating a metric (e.g., one or more data segments 306 that define the second period of time selected via the input referenced in block 704), is then input to the drift attribution model 110. Inputting one or more data segments 306 into the drift attribution model 110 causes the drift attribution model 110 to output drift observations 316 for the one or more data segments 306 (block 706). The drift observations 316 represent information that describes a magnitude by which each of the plurality of factors included in the input data segment(s) 306 that define the second time segment affect a value of a metric being evaluated, as observed during the second time segment.

For instance, by virtue of being trained to learn a relationship between each of the independent variables 208 and the dependent metric 206, the drift attribution model 110 is trained to identify divergences between a value of the metric as input to the drift attribution model 110 and a predetermined baseline of the metric as represented by the baseline training dataset 204. Similarly, the drift attribution model 110 is trained to identify how divergence of value for factors that affect the metric, relative to baseline values and distributions learned during training, impact the value of the metric observed during the second time segment. In this manner, the drift observations 316 are representative of a divergence value (e.g., a KL divergence metric, a JS divergence metric, a Wasserstein distance, etc.) for each of the metric factors 310.

The drift observations 316 generated by the drift attribution model 110 are then provided to a reporting module 318, which represents functionality of the metric evaluation system 104 to output a report that includes the drift observations 316 (block 708), represented by the metric drift report 106. In implementations, the reporting module 318 is configured to generate the metric drift report 106 by processing the drift observations 316 using a Shapley explainer. As described herein, a Shapley explainer refers to an algorithm configured to interpret the drift observations 316 based on the concept of Shapley values from cooperative game theory.

Shapley values assign a value to each agent (e.g., each metric factor 310 represented during training of the drift attribution model 110 by one of the independent variables 208) involved in the game, based on their contribution towards attaining the outcome (e.g., the metric being evaluated, represented during training of the drift attribution model 110 by the dependent metric 206). Specifically, to identify a value for each of the metric factors 310, the Shapley explainer implemented by the reporting module 318 considers all possible coalitions of every size without including the metric factor-enumerating the outcome first without the metric factor's involvement and then with the metric factor's involvement in the coalition. The assigned value of a metric factor's contribution is expressed as i in Equation 5, where N defines the space of all metric factors 310 contributing to a metric evaluated by the metric drift report 106, S identifies a coalition of some of the metric factors 310, and V(S) represents a contribution for a subset of metric factors 310 included in S.

$${Φ}_{i} ( v ) = {\sum }_{S ⊆ N / \{ i \}} \frac{\vert S \vert ! ( N - \vert S \vert - 1 ) !}{N !} ( ν ( S ⋃ \{ i \} ) - ν ( S ) ) \qquad ( Eq . 5 )$$

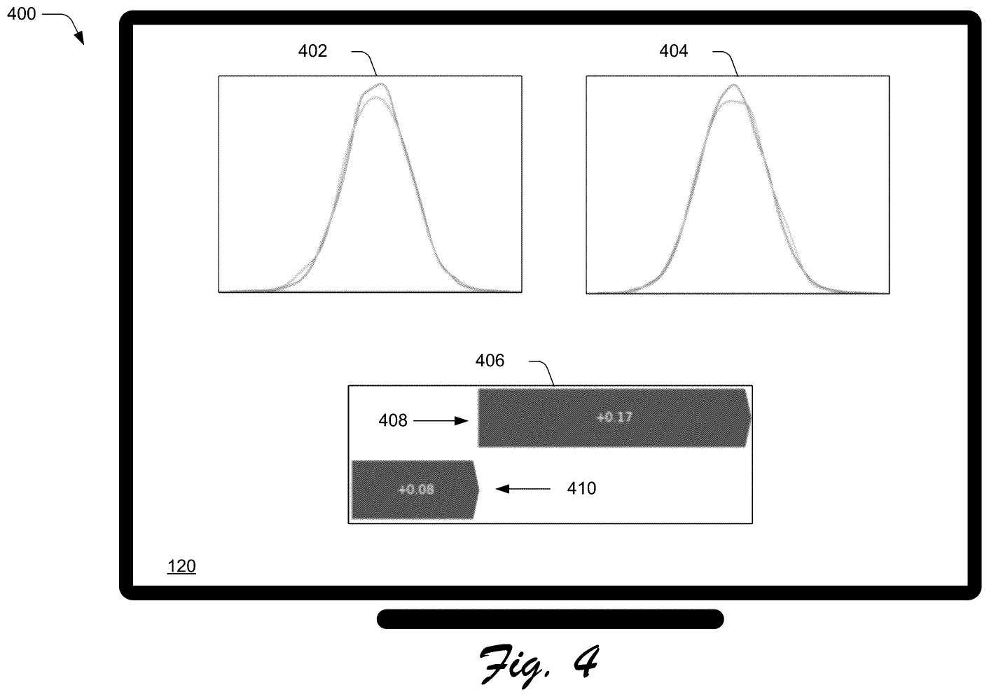

By implementing a Shapley explainer, the reporting module 318 generates the metric drift report 106 to represent contributions of each of the metric factors 310, and their associated value(s), relative to one or more observed values of a metric included in the corresponding data segment 306. Via the combination of training the drift attribution model 110 to identify divergences of individual metric factors 310 and their resulting magnitude of affecting a resulting metric value, and implementing a Shapley explainer to quantify the impact of each metric factors 310, the metric drift report 106 is generated to clearly convey how different factors impact a metric, in a manner that is visually intuitive. For examples of metric drift reports 106 generated by the reporting module 318, consider FIGS. 4-6.

FIG. 4 depicts an example 400 of a metric drift report 106 generated by the metric evaluation system of FIG. 1 in accordance with one or more implementations. In the illustrated example 400, the metric drift report 106 is displayed in a user interface 120 and represents a report for a metric with a value that depends on two factors. The metric drift report 106 depicts distribution plots for each factor-specifically distribution plot 402 and distribution plot 404. Distribution plot 402 visually represents how a distribution of observed values for a first factor (e.g., as observed during the time segment selected for evaluation) relate to a baseline distribution for the first factor as learned during training of the drift attribution model 110, where the blue line represents the factor distribution learned during training and the orange line represents the observed factor distribution being evaluated.

In a similar manner, distribution plot 404 visually represents how a distribution of observed values for a second factor (e.g., as observed during the time segment selected for evaluation) relate to a baseline distribution for the second factor as learned during training of the drift attribution model 110, where the blue line represents the factor distribution learned during training and the orange line represents the observed factor distribution being evaluated. The metric drift report 106 depicted in example 400 further includes a waterfall plot 406, which represents a magnitude by which each of the factors impacted a resulting value of the metric (e.g., as observed during the time segment selected for evaluation), relative to one another. For instance, the waterfall plot 406 denotes that the second factor 408, represented in distribution plot 404, had approximately twice the impact on the resulting metric value relative to an impact resulting from the first factor 410, represented in distribution plot 402. Given the similar distributions of observed values for the first factor 410 and the second factor 408 and values represented in training data (e.g., as represented by the similar blue and yellow curves in both distribution plot 402 and distribution plot 404), the example 400 represents a scenario where observed metric factors are closely aligned with expected baseline values. Consequently, the example 400 depicts a metric drift report 106 that indicates the observed deviations for a metric were less than expected (e.g., as learned during training the drift attribution model 110) and that the first factor 410 and the second factor 408 each contributed towards improving a value of the metric relative a baseline value for the metric.

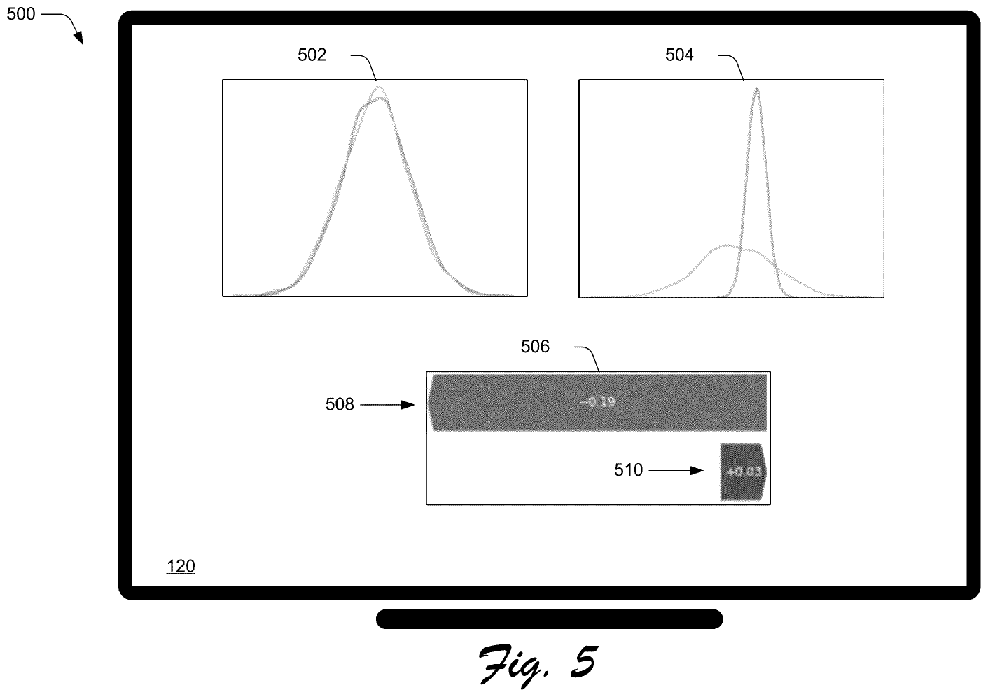

FIG. 5 depicts another example 500 of a metric drift report 106 generated by the metric evaluation system of FIG. 1 in accordance with one or more implementations. In the illustrated example 500, the metric drift report 106 is displayed in a user interface 120 and represents a report for a metric with a value that depends on two factors. The metric drift report 106 depicts distribution plots for each factor-specifically distribution plot 502 and distribution plot 504. Distribution plot 502 visually represents how a distribution of observed values for a first factor (e.g., as observed during the time segment selected for evaluation) relate to a baseline distribution for the first factor as learned during training of the drift attribution model 110, where the blue line represents the factor distribution learned during training and the orange line represents the observed factor distribution being evaluated.

The distribution plot 504 visually represents how a distribution of observed values for a second factor (e.g., as observed during the time segment selected for evaluation) relate to a baseline distribution for the second factor as learned during training of the drift attribution model 110, where the blue line represents the factor distribution learned during training and the orange line represents the observed factor distribution being evaluated. As illustrated by the distribution plot 504, the example 500 represents an instance where observed values for the second factor significantly deviate from a baseline distribution for the second factor.

The metric drift report 106 depicted in example 500 further includes a waterfall plot 506, which represents a magnitude by which each of the factors impacted a resulting value of the metric (e.g., as observed during the time segment selected for evaluation), relative to one another. For instance, the waterfall plot 506 denotes that the second factor 508, represented in distribution plot 504, had over six times as much of an impact on the resulting metric value relative to an impact resulting from the first factor 510, represented in distribution plot 502.

Given the similar distribution of observed values for the first factor 510 and the significantly dissimilar distribution of observed values for the second factor 508, the example 500 represents a scenario where one metric factor was observed to have values that significantly deviated from expected baseline values, while the other metric factor was observed to align with expected baseline values. Consequently, the example 500 depicts a metric drift report 106 that indicates the observed deviations for a metric were more than expected (e.g., as learned during training the drift attribution model 110). Further, the metric drift report 106 of example 500 identifies how the second factor 508 was observed to have a significant detrimental impact on a metric value, relative to a baseline value for the metric, while the first factor 510 had a positive impact on the value of the metric relative to its baseline, albeit insignificant to offset the detrimental impact of the second factor 508. Continuing the crop yield example from above, if the second factor 508 represents that a number of days with average temperatures below 60 degrees fahrenheit were substantially more than expected, the illustrated metric drift report 106 of FIG. 5 conveys that this factor significantly contributes to a crop yield for the corresponding time segment.

Although described and illustrated above in the context of a metric defined by two factors for purposes of simplicity, the techniques described herein are not so limited and are extendable to generating a metric drift report 106 for a metric defined by any number of factors.

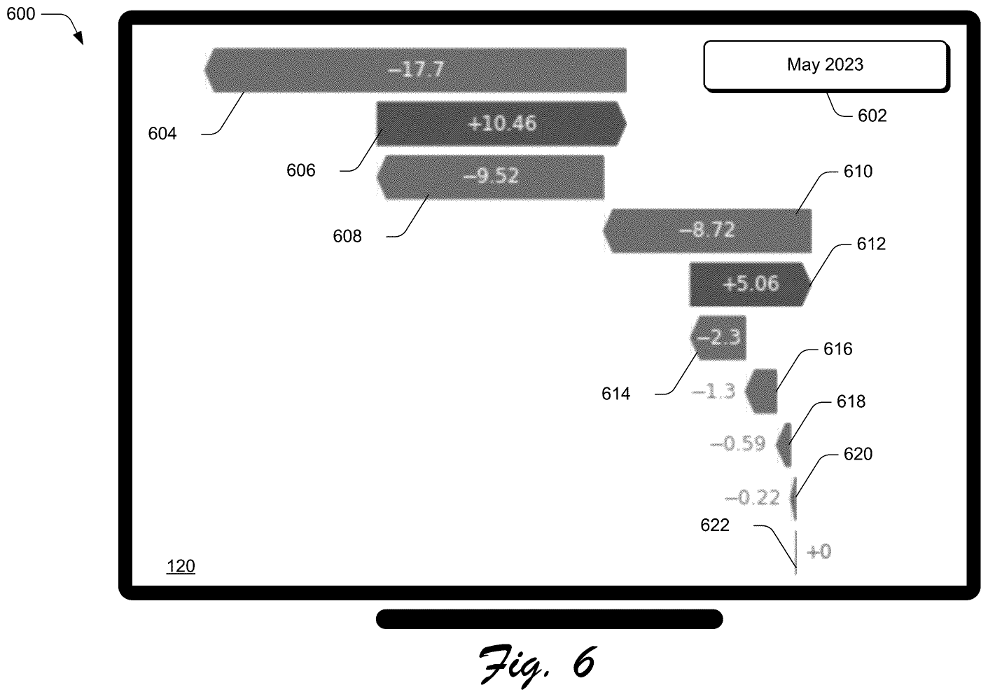

FIG. 6 depicts another example 600 of a metric drift report 106 generated by the metric evaluation system of FIG. 1 in accordance with one or more implementations.

In the illustrated example 600, user interface 120 displays a metric drift report 106 for a time segment spanning May 2023, as noted by indicator 602. The metric drift report 106 illustrated in example 600 describes a magnitude by which ten different factors affected a value of a metric, such as factor 604, factor 606, factor 608, factor 610, factor 612, factor 614, factor 616, factor 618, factor 620, and factor 622. The metric drift report 106 is generated in a manner that visually conveys the magnitude by which each factor impacts a metric relative to an expected baseline value for the metric, as well as relative to magnitudes by which other ones of the factors affected the metric.

For instance, the metric drift report 106 orders the metric, such as factor 604, factor 606, factor 608, factor 610, factor 612, factor 614, factor 616, factor 618, factor 620, and factor 622 based on a relative impact, such that factor 604, having a greatest impact on an observed metric value, is displayed at the top of the waterfall chart and factor 622, having no impact on the observed metric value, is displayed at the bottom of the waterfall chart. Factors having an overall positive impact or negligible impact on a resulting metric value are depicted using red arrows, while factors having an overall negative impact on the resulting metric value are depicted using blue arrows, where the arrows are each sized and positioned based on a magnitude of the factor's impact. Although described herein as representing impacts of individual factors on a metric, the metric drift report 106 is further configured to represent impacts of a combination of multiple factors on an observed metric value. For instance, in the context of FIG. 6, factor 618 may represent an impact resulting from a combination of multiple different factors on a metric value.

Although described and illustrated in the context of example waterfall charts configured with specific colors (e.g., red and blue), the metric drift report 106 is configurable in any suitable manner, such as including displays of bar charts, line charts, stacked column charts, area charts, force charts, tree map charts, bullet graphs, combinations thereof, and so forth. Thus, the metric evaluation system 104 is configured to implement a trained drift attribution model 110 to output a metric drift report 106 that describes, in an intuitive and clear manner, respective magnitudes by which each of a plurality of factors are determined to impact an observed value of a metric defined by the plurality of factors.

### Example System and Device

FIG. 9 illustrates an example system 900 that includes an example computing device 902 that is representative of one or more computing systems and/or devices that implement the various techniques described herein. This is illustrated through inclusion of the metric evaluation system 104 and the model training system 112. The computing device 902 is configurable, for example, as a server of a service provider, a device associated with a client (e.g., a client device), an on-chip system, and/or any other suitable computing device or computing system.

The example computing device 902 as illustrated includes a processing device 904, one or more computer-readable media 906, and one or more I/O interface 908 that are communicatively coupled, one to another. Although not shown, the computing device 902 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 904 is representative of functionality to perform one or more operations using hardware. Accordingly, the processing device 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 906 is illustrated as including memory/storage 912. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing device 904. The instructions and/or functions are executable/operable by one or more articles of manufacture (for example, one or more computing devices 902 and/or processing devices 904) to implement techniques, modules, and examples described herein.

The techniques described herein are supported by various configurations of the computing device 902 and are not limited to the specific examples of the techniques described herein. This functionality is also implementable all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized while computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device embodiment, implementation of functionality described herein is distributable throughout the system 900. For example, the functionality is implementable in part on the computing device 902 as well as via the platform 916 that abstracts the functionality of the cloud 914.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A system comprising:
a metric evaluation system implemented by one or more processing devices to perform operations including:
receiving data for a metric defined by a plurality of factors, the data describing at least one value for each of the plurality of factors observed during a first time segment;
computing a baseline value for each of the plurality of factors that defines a magnitude by which the factor influences a value of the metric;
receiving input defining a second time segment for evaluating the metric;
generating, using a trained drift attribution model, one or more drift observations that quantify a magnitude by which each of the plurality of factors affected the value of the metric during the second time segment; and
outputting a report that includes the one or more drift observations.

2. The system of claim 1, wherein the second time segment comprises a subset of time encompassed by the first time segment.

3. The system of claim 1, wherein the second time segment comprises a duration of time not encompassed by the first time segment.

4. The system of claim 1, wherein the metric evaluation system is further implemented to perform processing the data for the metric into a standardized format that expresses each of the plurality of factors as a numerical factor or a categorical factor, wherein the standardized format expresses numerical factors using count histograms and expresses categorical factors in terms of frequency.

5. The system of claim 1, wherein the metric evaluation system is further implemented to perform computing the baseline value for each of the plurality of factors is performed based on data observed during a third time segment in response to user input selecting the third time segment for defining a baseline value of the metric and the baseline value for each of the plurality of factors.

6. The system of claim 5, wherein computing the baseline value for each of the plurality of factors comprises generating a plurality of perturbed datasets from the data observed during the third time segment and training the drift attribution model to quantify divergences from the baseline value for each of the plurality of factors using the plurality of perturbed datasets.

7. The system of claim 1, wherein generating the one or more drift observations comprises causing the trained drift attribution model to compute a Kullback-Leibler divergence for each of the plurality of factors to quantify the magnitude by which each of the plurality of factors affected the value of the metric during for the second time segment.

8. The system of claim 1, wherein generating the one or more drift observations comprises causing the trained drift attribution model to compute a Jensen-Shannon divergence for each of the plurality of factors to quantify the magnitude by which each of the plurality of factors affected the value of the metric during for the second time segment.

9. The system of claim 1, wherein generating the one or more drift observations comprises causing the trained drift attribution model to compute a Wasserstein distance for each of the plurality of factors to quantify the magnitude by which each of the plurality of factors affected the value of the metric during for the second time segment.

10. The system of claim 1, wherein the metric evaluation system is further implemented to perform processing the one or more drift observations using a Shapley explainer to compute a value, for each of the plurality of factors, defining the magnitude by which each of the plurality of factors affected the value of the metric during for the second time segment, wherein the report includes the plurality of values computed using the Shapley explainer.

11. The system of claim 1, wherein the report includes a display that includes the plurality of factors and identifies the magnitude by which each of the plurality of factors affected the value of the metric during for the second time segment.

12. A method comprising:
training, by a processing device, a drift attribution model to generate drift observations that quantify a magnitude by which each of a plurality of factors affect a value of a metric by:
receiving a baseline dataset that includes a baseline value for the metric and a value for each of the plurality of factors that contribute to the baseline value for the metric;
generating, from the baseline dataset, a plurality of perturbed datasets that each include an altered value for at least one of the plurality of factors relative to the baseline dataset; and
causing a regression model to learn a relationship between each of the plurality of factors and the value of the metric by inputting the baseline dataset and the plurality of perturbed datasets to the regression model; and
outputting, by the processing device, the regression model as the drift attribution model with information describing a baseline value for each of the plurality of factors.

13. The method of claim 12, wherein causing the regression model to learn the relationship between each of the plurality of factors and the value of the metric comprises tasking the regression model with predicting, for each perturbed dataset, an altered value of the metric that results from the plurality of factors included in the perturbed dataset.

14. The method of claim 13, wherein each of the plurality of perturbed datasets includes an expected value for the metric that results from the plurality of factors included in the perturbed dataset, wherein the regression model is caused to learn the relationship between each of the plurality of factors and the value of the metric by tuning hyperparameters of the regression model based on a difference between the expected value for the metric and the altered value of the metric for a perturbed dataset.

15. The method of claim 12, further comprising:
receiving data for the metric that describes at least one value for each of the plurality of factors observed during a time segment; and
causing the drift attribution model to generate one or more drift observations that quantify a magnitude by which each of the plurality of factors affected the value of the metric during the time segment.

16. The method of claim 12, wherein generating the plurality of perturbed datasets comprises generating multiple datasets that alter values associated with a first one of the plurality of factors independent of altering values associated with a second one of the plurality of factors represented in the baseline dataset.

17. The method of claim 12, wherein generating the plurality of perturbed datasets comprises generating multiple datasets that alter values associated with a first one of the plurality of factors using a first distribution and alter values associated with a second one of the plurality of factors using a second distribution that is different from the first distribution.

18. A computer-readable storage medium storing instructions that are executed by a processing device and cause the processing device to perform operations comprising:
receiving input that identifies a metric, which is defined by a value influenced by a plurality of factors, to be evaluated;
selecting a drift attribution model that is trained to evaluate the metric;
causing the drift attribution model to generate drift observations for an observed value of the metric, the drift observations quantifying a magnitude by which an observed value for each of the plurality of factors affected the observed value of the metric;
generating a report that includes a visual representation of the drift observations; and
outputting a display of the report.

19. The computer-readable storage medium of claim 18, the operations further comprising training the drift attribution model to generate the drift observations that quantify the magnitude by which each of the plurality of factors affect the value of the metric using training datasets that each include an example value for the metric and an example value for each of the plurality of factors.

20. The computer-readable storage medium of claim 18, wherein generating the report that includes the visual representation of the drift observations comprises processing the drift observations using a Shapley explainer to compute a value, for each of the plurality of factors, defining the magnitude by which each of the plurality of factors affected the observed value of the metric.
